(19) United States
(12) Patent Application Publication
(10) Pub. No.: US 2004/0107525 A1
(43) Pub. Date: Jun. 10, 2004

(54) Paint edger with horizontal and vertical guide wheels

(76) Inventors: Robert D. Newman, Greenwood, MO (US); Buford J. Guittar, Greenwood, MO (US)

Correspondence Address: HOVEY WILLIAMS LLP, 2405 GRAND BLVD., SUITE 400, KANSAS CITY, MO, 64108, US

(21) Appl. No.: 10/065,990

(22) Filed: Dec. 6, 2002

(51) Int. Cl. B05C 17/00

(52) U.S. Cl. 15/210.1

(57) ABSTRACT

An edger (10) constructed in accordance with a preferred embodiment of the present invention and configured for applying paint to a paintable surface abutting non-paintable bordering surfaces is disclosed. The edger (10) broadly includes a head assembly (12) and a handle assembly (14) couplable to the head assembly (12). The head assembly (12) broadly includes a base (16), an applicator (18) coupled to the base (16), and an edging guide subassembly (20) supported by the base (16). The edging guide subassembly (20) includes a plurality of rotatable guide wheels (64, 66 and 68) configured to engage bordering surfaces (C) and (A) to maintain an applicator pad (50) at a uniform spacing from the surfaces (C,A) when applying paint to a wall (W). The edging guide (20) enables the edger (10) to provide smooth, continuous and uniform lines of demarcation along joints (J_{A} J_{C}) without undesirably applying paint to the bordering surfaces (A,C). Furthermore, the improved edging guide (20) enables the edger (10) to apply paint along convergent, multidirectional joints (J_{A} J_{C}) by changing the leading edge of the applicator (18) without having to reposition the edger (10) during the continuous application.

### BACKGROUND OF INVENTION

1. Field of the Invention

The present invention relates generally to equipment for applying paint to a surface. More specifically, the present invention concerns an edger including guides on at least two sides for applying paint to a surface that abuts two differing borders. The inventive edger enables paint to be continuously applied to the surface, and uniformly along the borders (without applying paint to the borders), without having to reposition the edger during the continuous application.

2. Discussion of Prior Art

It is known in the art to utilize an applicator, such as a pad or a roller, to apply paint or other coatings to various surfaces such as the walls and ceilings of the interior of a home or building. Often times, it is desirable to apply paint to a surface that abuts one or more borders or adjacent surfaces without applying paint to the bordering surface or surfaces. When applying paint to a paintable surface abutting a bordering surface, the applicator is typically moved along the paintable surface with a leading edge of the applicator positioned perpendicular to the joint between the paintable and bordering surfaces and an abutment edge of the applicator positioned adjacent the joint. The leading edge of the applicator will vary according to the direction the joint extends along. For example, when using a rectangular pad-type applicator, when the joint extends horizontally, such as a ceiling joint, the leading edge is typically one of the minor-dimensioned edges and when the joint extends vertically, such as a wall joint, the leading edge is typically one of the major-dimensioned edges. When a paintable surface adjoins multiple bordering surfaces extending in different directions (e.g., horizontally and vertically), a plurality of joints are presented, with the joints extending in the different directions. For example, when applying paint to an interior wall joined to a ceiling and including a trimmed doorway, a horizontal ceiling joint and at least one vertical trim joint are presented. It is desirable to completely cover the wall up to the ceiling joint and around the doorway without applying paint to the ceiling or the doorway trim. It is further desirable to maintain a smooth and uniform line of demarcation along the joints between the paintable wall surface and the adjacent, non-paintable bordering surfaces.

It is known in the art to utilize an edger that guides an applicator along the paintable surface and maintains a uniform spacing from one adjacent non-paintable surface. For example, prior art edgers utilize a pair of guide wheels extending over one abutment edge of the applicator. The guide wheels engage the bordering surface and guide the applicator along the joint. However, these prior art edgers are problematic and subject to several undesirable limitations. For example, when using a prior art edger to apply paint to a surface adjoining multiple joints extending in different directions, the edger must be repositioned between joints in order to move the guide wheels from one bordering surface to the next. Repositioning the edger is undesirable as it is inefficient and increases the risk of applying unwanted paint to the bordering surface. Additionally, where two joints converge, the prior art edger cannot maintain a uniform line of demarcation throughout the convergence. For example, when the guide wheels are positioned against a ceiling joint and the applicator is moved along the ceiling joint, the leading edge of the applicator is free to engage a convergent wall joint thereby undesirably applying paint to the bordering surface or varying the line of demarcation between the ceiling joint and the wall joint.

### SUMMARY OF INVENTION

The present invention provides an improved edger that does not suffer from the problems and limitations of the prior art edgers detailed above. The inventive edger provides improved guides that enable paint to be continuously applied to a paintable surface and uniformly along multidirectional joints bordering the paintable surface without applying paint to the bordering surfaces. The improved guides further enable the inventive edger to apply paint along convergent, multidirectional joints by changing the leading edge of the applicator without having to reposition the edger during the continuous application. The edger of the present invention therefore provides smooth, continuous and uniform lines of demarcation along the joints of bordering, non-paintable surfaces.

A first aspect of the present invention concerns an edger for applying paint to a surface. The edger broadly includes a head assembly including an applicator and an edging guide associated with the applicator. The applicator is operable to store a quantity of paint therein and defines a paint-applying face operable to engage the surface and thereby transfer paint to the surface. The face presents relatively unparallel first and second outer edges. The edging guide extends outwardly beyond the first and second outer edges to present a first outer margin fixed relative to and generally parallel to the first outer edge and a second outer margin fixed relative to and generally parallel to the second outer edge. The first and second outer margins are each defined by at least two linearly spaced points.

A second aspect of the present invention concerns an edger for applying paint to a surface. The edger broadly includes a head assembly including a base, a pad supported on the base, and an edging guide coupled to the base. The pad is operable to store a quantity of paint therein and defines a paint-applying face operable to engage the surface and thereby transfer paint to the surface. The face presents relatively unparallel first and second outer edges. The edging guide includes first and second rotatable wheels. The first wheel presents a first diametrical surface having at least a portion thereof extending outwardly beyond said first outer edge. The second wheel presents a second diametrical surface having at least a portion thereof extending outwardly beyond the second outer edge.

Other aspects and advantages of the present invention will be apparent from the following detailed description of the preferred embodiments and the accompanying drawing figures.

### BRIEF DESCRIPTION OF DRAWINGS

Preferred embodiments of the invention are described in detail below with reference to the attached drawing figures, wherein:

FIG. 1 is an exploded assembly view of an edger constructed in accordance with a preferred embodiment of the present invention and illustrating the handle assembly pivotable through one-hundred and eighty degrees of pivot from a left-hand leading edge position (shown in phantom in front) through a center position to a right-hand leading edge position (shown in phantom in rear);

FIG. 2 is a perspective view of the edger illustrated in FIG. 1 and shown in use along a paintable wall surface with bordering non-paintable ceiling and wall surfaces presenting converging multidirectional joints;

FIG. 3 is a plan view of the edger illustrated in FIGS. 1 and 2 with the handle assembly being removed;

FIG. 4 is a sectional view of the edger taken substantially along line 4-4 of FIG. 3 showing the head assembly in a flexed position and illustrating the handle assembly partially inserted into the connector on the base;

FIG. 5 is a fragmentary side elevational view of the edger shown in FIG. 4 with the handle assembly and portions of the surrounding head assembly shown in section; and

FIG. 6 is a perspective view of an edger constructed in accordance with a preferred alternative embodiment of the present invention and shown in use along a paintable wall surface with bordering non-paintable ceiling and wall surfaces presenting converging multidirectional joints.

### DETAILED DESCRIPTION

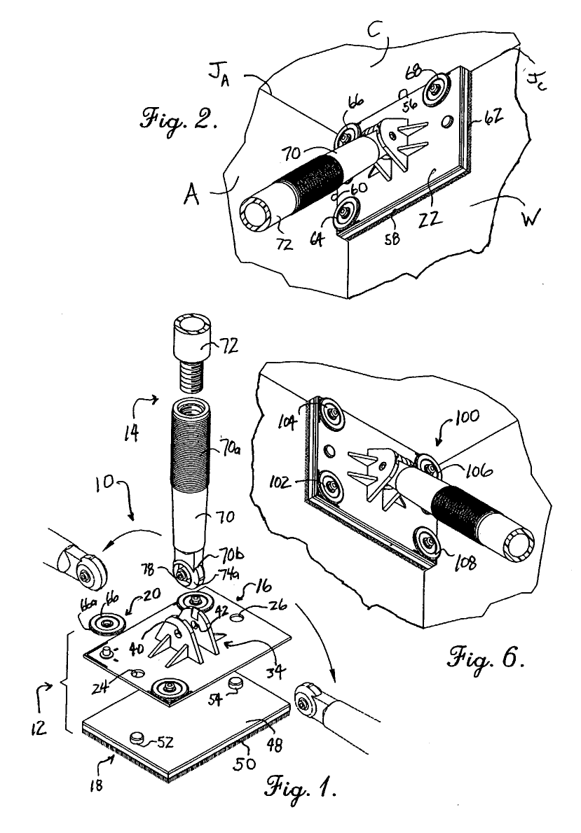

FIG. 1 illustrates an edger 10 constructed in accordance with a preferred embodiment of the present invention. The edger 10 is configured for applying paint to a surface, particularly a paintable surface abutting non-paintable bordering surfaces. For example, as shown in FIG. 2, the edger 10 is particularly well suited for applying paint to an interior wall W (such as in a home or other building) that borders converging non-paintable surfaces (i.e., surfaces the user does not desire to apply paint to during the current application) such as a ceiling C and an adjacent wall A. The bordering surfaces C,A each adjoin the wall W to define corresponding joints J_{C} and J_{A}, respectively. The wall W and the surfaces C,A each extend in different directional planes that intersect at a common corner. Therefore, the joints J_{C} J_{A} are converging multidirectional joints. However, the principles of the present invention equally apply to edgers for applying virtually any coating to any type of surface. The illustrated edger 10 broadly includes a head assembly 12 and a handle assembly 14 couplable to the head assembly 12. The head assembly 12 broadly includes a base 16, an applicator 18 coupled to the base 16, and an edging guide subassembly 20 supported by the base 16.

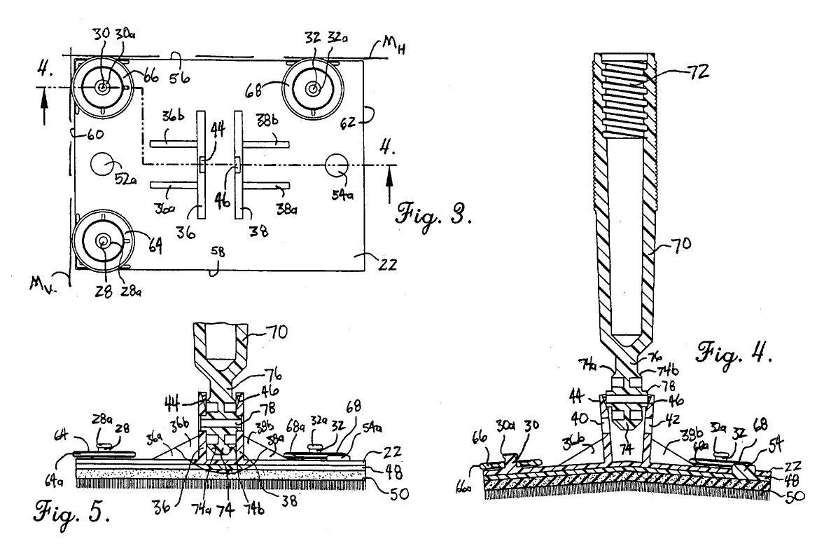

As shown in FIG. 1, the base 16 is configured to support the applicator 18, the edging guide 20 and the handle assembly 14. In more detail, as further shown in FIGS. 3-5, the illustrated base 16 includes a generally flat, rectangular plate 22. For purposes that will subsequently be described, the plate 22 is preferably flexible, such as formed from a plastic. For purposes that will subsequently be described, the plate 22 is configured to removably receive the applicator 18. In this regard, the illustrated plate 22 includes a pair of spaced apertures 24 and 26 formed through the plate 22 (see FIG. 1). The plate 22 is also configured to rotatably support components of the edging guide subassembly 20 (as detailed below). Particularly, the illustrated plate 22 includes bossed posts 28, 30 and 32 formed adjacent three of the four corners of the rectangular plate 22. The posts 28,30,32 each project out of the top face of the plate 22. For purposes that will be described below, each of the posts 28,30,32 includes a complemental post cap 28a, 30a and 32a, respectively, that can be separately joined to the corresponding post 28,30,32 during assembly. The illustrated plate 22 is further configured to pivotally receive the handle assembly 14. In this regard, the plate 22 includes a connector 34 coupled to the top face of the plate 22 (see FIGS. 1 and 3). The illustrated connector 34 includes a pair of opposed, spaced apart lugs 36 and 38 projecting out of the top face of the plate 22. Each of the lugs 36,38 is gusseted to the plate 22 by a pair of corresponding gussets 36a, 36b and 38a, 38b, respectively. Each of the lugs 36,38 includes a shaft-receiving hole 40 and 42, formed through the corresponding lug 36,38, respectively (see FIGS. 1 and 3). For purposes that will subsequently be described, formed in the inner face of each of the lugs 36,38 directly above the respective hole 40,42 is a corresponding recessed cam surface 44 and 46. Each of the cam surfaces 44,46 ramps inwardly toward the opposing lug from the top of the corresponding lug 36,38 to the adjacent hole 40,42 (see FIGS. 4 and 5). A similar and suitable connector is disclosed in U.S. Pat. No. 5,293,662 issued Mar. 15, 1994 entitled CORNER PAINT PAD ASSEMBLY (sharing a common inventor and assigned to a common assignee as the current application), which is hereby incorporated by reference herein as is necessary for a complete understanding of the present invention. In the illustrated base 16, the connector 34, as well as the posts 28,30,32, are integrally formed with the plate 22 (e.g., molded, etc.). However, it is within the ambit of the present invention to utilize any suitable alternative configurations for the base, including, for example, alternative connector, post and plate components removably coupled together.

Turning to FIGS. 1 and 4-5, the applicator 18 is coupled to the base 16 and is operable to store a quantity of paint therein and engage the wall W to thereby transfer paint to the wall W. The illustrated applicator 18 is a pad-type applicator including a substrate 48 removably coupled to the base 16 and a pad 50 fixed to the substrate 48. The substrate 48 is a generally flat rectangular body presenting an upper face that engages the bottom face of the plate 22 in a flush relationship when the applicator 18 is coupled to the base 16. The substrate 48 is removably coupled to the plate 22. In this regard, the substrate 48 includes a pair of detents 52 and 54 projecting from the upper face and configured to be received in the corresponding apertures 24 and 26 of the plate 22 (see FIGS. 1 and 3). Each of the detents 52,54 includes a bossed head section 52a and 54a, respectively, configured to be pressed through the corresponding aperture 24,26 and yieldably retain the substrate 48 coupled to the plate 22 (see FIGS. 1 and 4). To remove the substrate 48 (and thus the pad 50) from the plate 22, the head sections 52a,54a can simply be forced back through the apertures 24,26. The use of a substrate is preferable when using a flexible plate. In this manner, the substrate facilitates the prevention of undesirably dripping paint out of the pad when pressure is applied to the handle that would otherwise cause the plate to flex. However, it is within the ambit of the present invention to utilize an applicator that does not include a substrate backing.

The pad 50 is fixed to the lower face of the substrate 48 and is operable to store paint and transfer the paint stored therein to the wall W when the pad 50 engages the wall W. In one manner known in the art, the illustrated pad 50 is formed from a flocked foam that is adhered to the lower face of the substrate 48. The pad 50, like the plate 22 and the substrate 48, is generally rectangular. The illustrated pad 50 is preferably sized and dimensioned to be compatible with conventional industry dimensions for similar pads (e.g., a major dimension of four and three-quarters inches and a minor dimension of three and three-eighths inches). The pad 50 is preferably coextensive with the substrate 48 and the plate 22. In this manner, the pad 50 generally presents outermost edges that are coextensive with or define the outer boundaries of the combination of the plate 22, the substrate 48 and the pad 50. In this regard, the pad 50 presents a bottom paint-applying face that defines a pair of oppositely spaced major dimensioned edges 56 and 58 and a pair of oppositely spaced minor dimensioned edges 60 and 62 (designated as edges coextensive with the edges of the plate 22 in FIG. 3 for purposes of illustration). As previously indicated, the pad 50 is rectangular and therefore the edges 56,58,60,62 are generally coplanar with the edges 56,58 being generally parallel to each other and the edges 60,62 being generally parallel to each other and extending generally perpendicularly between the edges 56,58. However, It is within the ambit of the present invention to utilize various alternative materials, dimensions, shapes, configurations, etc. for the applicator 18. For example, the applicator could comprise a pump-type applicator or a roller-type applicator.

The edging guide subassembly 20 is supported on the plate 22 and is configured to engage the bordering surfaces C and A to maintain the pad 50 at a uniform spacing from the surfaces C,A when applying paint to the wall W. In more detail, and as shown in FIGS. 1-3, the illustrated edging guide includes a plurality of guide wheels 64, 66 and 68 rotatably supported on the corresponding posts 28, 30 and 32, respectively. Each of the wheels 64,66,68 is a generally flat disk presenting a central opening that receives the corresponding post and integrally formed washers on either side of the opening that act as bearings against the bossed portion of the post and the post caps. The illustrated wheels 64,66,68 are molded plastic wheels that are inserted onto the posts 28,30,32 during assembly. Once each of the wheels 64,66,68 is positioned on the corresponding post 28,30,32, the respective post cap 28a,30a,32a is fixed to the complemental post 28,30,32 (e.g., by spot welding, etc.) to prevent the wheels 64,66,68 from being removed from the posts 28,30,32. Each of the wheels 64,66,68 presents a corresponding diametrical surface 64a, 66a and 68a, respectively (see FIGS. 1 and 5). Each of the diametrical surfaces 64a,66a,68a extends entirely around the diameter of the corresponding wheel 64,66,68 and defines the radially outermost boundary of the respective wheel 64,66,68. Each of the wheels 64,66,68 is substantially round and thus the respective diametrical surfaces 64a,66a,68a are substantially uniformly spaced radially from the center of the corresponding posts 28,30,32. The central opening formed in each of the wheels 64,66,68 is configured to allow the wheels 64,66,68 to freely rotate around the corresponding post 28,30,32. Accordingly, depending upon manufacturing tolerances, there may be some “play” in the spacing of the diametrical surfaces 64a,66a,68a relative to the center of the respective post 28,30,32. This is within the ambit of the present invention. However, for purposes that will subsequently be describe, it is important that the spacing of the diametrical surfaces 64a,66a,68a relative to the center of the respective post 28,30,32 remain sufficiently uniform to ensure at least a portion of each of the diametrical surfaces 64a,66a,68a extends beyond at least one of the edges 56,58,60,62.

The wheels 64,66 and the corresponding posts 28,30 are configured and dimensioned so that at least a portion of each of the diametrical surfaces 64a,66a extends outwardly beyond the minor edge 60 (see FIGS. 3 and 5). The diametrical surfaces 64a,66a preferably extend a substantially equal distance beyond the edge 60 so that the radially outermost point presented by each of the surfaces 64a,66a is equal distance from the edge 60. In this manner, the radially outermost point presented on each of the portions of the diametrical surfaces 64a,66a that extends outwardly beyond the edge 60 cooperate to define an outer vertical margin (designated as _{MV} in FIG. 3). The vertical margin M_{V} is fixed relative to the edge 60 and generally parallel thereto. That is to say, although the wheels 64,66, and thus the diametrical surfaces 64a,66a, rotate along the bordering wall surface A as paint is applied to the wall W, the spacing of the vertical margin M_{V} relative to the edge 60 remains constant. The spacing of the vertical margin M_{V} relative to the edge 60 is preferably minimized while still preventing paint from the pad 50 to be undesirably applied to the bordering non-paintable surface A. This spacing is preferably minimized so that the line of demarcation between the painted surface and the bordering unpainted surfaces appears to be at or very near the joint J_{A}. In this regard, as the pad 50 is moved along the wall W adjacent the joint J_{A} (e.g., downwardly as shown in FIG. 2) to apply paint thereto, the diametrical surfaces 64a,66a engage and roll along the adjoining wall A to maintain uniform spacing of the edge 60 of the pad 50 from the wall A. Accordingly, the edging guide 20 enables the edger 10 to provide smooth, continuous and uniform lines of demarcation along the joint J_{A}.

In a similar manner, the wheels 66,68 and the corresponding posts 30,32 are configured and dimensioned so that at least a portion of the diametrical surface 68a and a second portion of the diametrical surface 66a (different than the first portion discussed above) each extends outwardly beyond the major edge 56 (see FIG. 3). Just as with the surface 64a and the first portion of the surface 66a discussed above, the diametrical surface 68a and the second portion of the diametrical surface 66a each preferably extends a substantially equal distance beyond the edge 56 so that the radially outermost points presented thereby are equal distance from the edge 56. Accordingly, similar to the vertical margin M_{V} previously described, the radially outermost point presented on the portion of the diametrical surface 68a and the second portion of the diametrical surface 66a that extend outwardly beyond the edge 56 cooperate to define an outer horizontal margin (designated as _{MH} in FIG. 3). The horizontal margin M_{H} is fixed relative to the edge 56 and generally parallel thereto. The horizontal margin M_{H} is preferably spaced from the edge 56 the same distance as the vertical margin M_{V} is spaced from the edge 60. As the pad 50 is moved along the wall W adjacent the joint J_{C} (e.g., horizontally as shown in FIG. 2) to apply paint thereto, the diametrical surfaces 66a,68a engage and roll along the adjoining ceiling C to maintain uniform spacing of the edge 56 of the pad 50 from the ceiling C. Accordingly, the edging guide 20 enables the edger 10 to provide smooth, continuous and uniform lines of demarcation along the joint J_{C} that are virtually identical to the lines of demarcation along the joint J_{A} as detailed above.

As indicated above, each of the margins M_{V},M_{H} enables the edger 10 to apply paint to the wall surface W up to the multidirectional joints J_{A} J_{C} of the non-paintable bordering surfaces A,C without undesirably applying paint to the surfaces A,C. Additionally, the unique configuration of the margins M_{V},M_{H} of the edging guide 20 prevent the user from undesirably contacting bordering surfaces with paint when applying paint in the area of converging multidirectional joints (i.e., a corner, etc.). For example, when moving the edger 10 from right-to-left along the joint J_{C} (see FIG. 2), the horizontal margin M_{H} maintains a smooth and uniform line of demarcation along the joint J_{C}, however, the vertical margin M_{V} prevents the user from accidently running the pad 50 into the wall A thereby undesirably applying paint to the wall surface A. Furthermore, the improved edging guide 20 further enables the edger 10 to apply paint along convergent, multidirectional joints J_{A} J_{C} by changing the leading edge of the applicator 18 without having to reposition the edger 10 during the continuous application. For example, as shown in FIG. 2, the edger 10 can apply paint along the ceiling joint J_{C} by positioning the edge 56 adjacent the ceiling C so that the horizontal margin M_{H} engages the ceiling C and then moving the face of the pad 50 along the wall W from right-to-left until the vertical margin M_{V} engages the adjacent wall A. Once the diametrical surfaces 64a,66a engage the wall A, the edger can simply be pulled down, i.e., moving the face of the pad 50 along the joint J_{A} from top-to-bottom. In this manner, the edger 10 never has to be repositioned during this continuous paint application and the pad 50 never has to disengage the wall surface W. It is within the ambit of the present invention to utilize various alternative configurations for the edging guide. For example, the edging guide need not be associated with a base and need not include wheels to define the margins. However, it is important that the edging guide provide an outer margin spaced from at least a pair of potential leading edges of the applicator.

As previously indicated, the handle assembly 14 is coupled to the head assembly 12 and can be used to move the applicator 18 along the wall W. In more detail, and as shown in FIGS. 1-2 and 4-5, the illustrated handle assembly 14 includes a handle 70 coupled to the base 16 and an extension pole 72 coupled to the handle 70. The handle 70 is generally cylindrical and presents a gripable section 70a at its distal end and a coupling 70b at its proximate end. The gripable section 70a presents circumscribing exterior ribs configured to grippingly fit within the hand of a user. The coupling 70b is spaced from the gripable section 70a and pivotally couples the handle 70 to the connector 34. Particularly, the coupling 70b comprises a wheel-like joint 74 carried on an arm 76. The joint 74 includes an axle 78 configured to snugly but rotatingly be received within the holes 40 and 42 in the lugs 36 and 38. The joint 74 further presents ramped edges 74a and 74b configured to engage the lugs 36,38 to facilitate inserting the joint 74 into the connector 34. In this regard, the joint 74 is inserted between the lugs 36,38 of the connector 34 so that the ends of the axle 78 engage the cam surfaces 44,46. The ramped edges 74a,74b of the joint 74 and the engagement of the axle 78 with the cam surfaces 44,46 cooperate to spread the lugs 36,38 apart as the joint 74 is pushed into the connector 34 (see FIG. 4). The flexibility of the plate 22 enables the plate 22 to flex sufficiently to allow the lugs 36,38 to separate to receive the joint 74 as shown in FIG. 4. The joint 74 is received in the connector 34 when the axle 78 “snaps” into the holes 40,42 as shown in FIG. 5. In this regard, the flexible plate 22 is sufficiently resilient to provide the snap fit between the joint 74 and the connector 34. The arm 76 is sized and dimensioned to fit between the lugs 36,38 of the connector 34 so as not to interfere therewith as the handle 70 pivots through its full range of motion. A similar and suitable joint is disclosed in the U.S. Pat. No. 5,293,662 previously incorporated herein by reference.

The wheel joint 74 and the connector 34 cooperate to provide the handle assembly 14 with a pivotal range of motion of substantially one-hundred and eighty degrees relative to the plate 22. As shown in FIG. 1, the handle 70 pivots from a left-hand leading edge position (shown in phantom in front) through a center position (shown in full) to a right-hand leading edge position (shown in phantom in rear). This range of motion enables the edger 10 to facilitate applying paint to a surface by moving the edger 10 in virtually any direction while still providing the edging guide functions detailed above. For example, by placing the handle 70 in the left-hand leading edge position, the edger 10 can be moved horizontally from right-to-left (as shown in FIG. 2) with the edge 60 being the leading edge (and the edge 56 being the abutment edge) and thus the vertical margin M_{V} providing protection against undesirably running the pad 50 into a bordering surface (e.g., the wall A). By pivoting the handle 70 into the right-hand leading edge position, the edger 10 can be moved horizontally from left-to-right to apply paint and still provide the leading edge protection provided by the vertical margin M_{V}. In this same manner, the handle 70 can be pivoted to either one of the previously described positions and the edge 10 can be moved vertically either up or down with the edge 56 being the leading edge and the horizontal margin M_{H} providing protection against undesirably contacting a bordering surface (e.g., the ceiling C) with the pad 50.

The extension pole 72 can be inserted into the handle 70 to enable the user to manipulate the edger 10 from a remote location. For example, the use of the extension pole 72 could enable the user to stand on the floor without the aid of a ladder and use the edger 10 to apply paint along the top of the wall W adjacent the joint J_{C} as shown in FIG. 2. In more detail, in one manner known in the art, the handle 70 includes internal threading at its distal end and the extension pole 72 includes complemental external threading at its proximate end to enable the pole 72 to be threadably coupled to the handle 70. The extension pole 72 could be virtually any suitable length but is preferably of sufficient length to enable the user to stand on the floor and apply paint with the edger 10 to a conventional ceiling surface (e.g., a ceiling spaced eight-ten feet from the floor). It is within the ambit of the present invention to utilize various alternative configurations for the handle assembly, including any known manner for coupling the handle and the extension pole. Additionally, the handle assembly could include only an extension pole coupled to the head assembly or only a handle and no extension pole. It is also within the ambit of the present invention to use the head assembly without a handle assembly.

In operation, and as shown in FIGS. 1 and 2, the edger 10 is assembled by snapping the applicator 18 to the base 16 to form the head assembly 12 and then snapping the handle assembly 14 to the head assembly 12. Once assembled, the edger 10 can be used to apply paint to the wall surface W. First, a quantity of paint is stored in the pad 50 (e.g., by dipping the pad 50 into a paint tray or can, etc.). The pad 50 is then positioned against the wall W so that the paint-applying face of the pad 50 engages the surface of the wall W. The edger 10 is then moved along the wall W to apply paint thereto. The edger 10 is particularly well suited to continuously apply paint along the joints J_{C} J_{A}. The edger 10 is positioned adjacent the ceiling C so that the diametrical surfaces 66a,68a of the guide wheels 66,68 engage the ceiling C. The edger 10 is then moved along the joint J_{C} from right-to-left (when viewed as in FIG. 2) so that the pad 50 slides along the wall W and the guide wheels 66,68 roll along the ceiling C. The edger 10 is guided along the joint J_{C} until the diametrical surfaces 64a,66a of the guide wheels 64,66 engage the adjoining wall A (as shown in FIG. 2). Once the guide wheels 64,66 engage the wall A, the edger 10 is then pulled downwardly along the joint J_{A} so that the pad 50 slides downwardly along the wall W and the guide wheels 64,66 roll along the wall A. In this manner, the edger 10 applies paint along the convergent, multidirectional joints J_{C} J_{A} by changing the leading edge of the applicator 18 from the edge 60 to the edge 58 without having to reposition the edger 10 during the continuous application. As a result, the edger 10 provides smooth, continuous and uniform lines of demarcation along the joints J_{C} J_{A} of the bordering, non-paintable surfaces C,A without undesirably applying paint to the ceiling C or the wall A.

As indicated above, it is within the ambit of the present invention to utilize various alternative configurations for the edging guide. One such preferred alternative is included in the edger 100 illustrated in FIG. 6. The edger 100 is similar to the edger 10 detailed above. However, the edger 100 includes four guide wheels 102, 104, 106 and 108. The guide wheels 102,104,106,108 are similarly constructed as the previously discussed guide wheels 64,66,68. The guide wheels 102,104,106,108, however, are each configured and positioned on the edger 100 so that portions of each of the diametrical surfaces presented thereby extend outwardly beyond at least two adjacent edges of the applicator pad. In this regard, the edger 10 presents guide margins, similar to the margins M_{V},M_{H} described above, along all four of the edges of the applicator pad. In this manner, all edges of the applicator pad of the edger 100 can be used as the leading edge when applying paint with the edger 100 and regardless of the leading edge being utilized, that edge will have a protective guide margin.

The preferred forms of the invention described above are to be used as illustration only, and should not be utilized in a limiting sense in interpretthe scope of the present invention. Obvious modifito the exemplary embodiments, as hereinset forth, could be readily made by those skilled in the art without departfrom the spirit of the present invenThe inventors hereby state their intent to rely on the Doctrine of Equivalents to deterand assess the reasonably fair scope of the present invention as pertains to any apparatus not materially departing from but outside the literal scope of the invention as set forth in the following claims.

1. An edger for applying paint to a surface, said edger comprising:
a head assembly including an applicator and an edging guide associated with the applicator,
said applicator being operable to store a quantity of paint therein and defining a paint-applying face operable to engage the surface and thereby transfer paint to the surface,
said face presenting relatively unparallel first and second outer edges,
said edging guide extending outwardly beyond the first and second outer edges to present a first outer margin fixed relative to and generally parallel to the first outer edge and a second outer margin fixed relative to and generally parallel to the second outer edge,
said first and second outer margins each being defined by at least two linearly spaced points.

2. The edger as claimed in claim 1,
said head assembly including a base presenting a generally flat rectangular plate,
said applicator being coupled to the base.

3. The edger as claimed in claim 2,
said applicator comprising a foam pad removably coupled to said plate.

4. The edger as claimed in claim 3,
said pad being generally rectangular so that the first and second outer edges are generally coplanar and perpendicular,
said pad being generally coextensive with said plate.

5. The edger as claimed in claim 1,
said head assembly including a base,
said edging guide including a first wheel rotatably supported on the base.

6. The edger as claimed in claim 5,
said first wheel presenting a first diametrical surface,
at least a portion of said first diametrical surface extending outwardly beyond said first outer edge,
one of said at least two linearly spaced points of said first outer margin being defined on said at least a portion of said first diametrical surface.

7. The edger as claimed in claim 6,
said edging guide including a second wheel rotatably supported on said base and spaced from said first wheel.

8. The edger as claimed in claim 7,
said second wheel presenting a second diametrical surface,
at least a portion of said second diametrical surface extending outwardly beyond said first outer edge,
the other one of said at least two linearly spaced points of said first outer margin being defined on said at least a portion of said second diametrical surface.

9. The edger as claimed in claim 8,
said edging guide including a third wheel rotatably supported on said base and spaced from said first and second wheels.

10. The edger as claimed in claim 9,
said third wheel presenting a third diametrical surface,
at least a portion of said third diametrical surface extending outwardly beyond said second outer edge,
one of said at least two linearly spaced points of said second outer margin being defined on said at least a portion of said third diametrical surface.

11. The edger as claimed in claim 10,
at least an additional portion of said second diametrical surface extending outwardly beyond said second outer edge,
the other one of said at least two linearly spaced points of said second outer margin being defined on said at least an additional portion of said second diametrical surface.

12. The edger as claimed in claim 1,
said second outer edge being generally coplanar and perpendicular to said first outer edge,
said face further presenting a third outer edge spaced from said first outer edge,
said third outer edge being generally coplanar and parallel to said first outer edge,
said edging guide extending outwardly beyond the third outer edge to present a third outer margin fixed relative to and generally parallel to the third outer edge,
said third outer margin being defined by at least two linearly spaced points.

13. The edger as claimed in claim 12,
said face further presenting a fourth outer edge spaced from said second outer edge,
said fourth outer edge being generally coplanar and parallel to said second outer edge,
said edging guide extending outwardly beyond the fourth outer edge to present a fourth outer margin fixed relative to and generally parallel to the fourth outer edge,
said fourth outer margin being defined by at least two linearly spaced points.

14. The edger as claimed in claim 13,
said edging guide comprising at least four wheels spaced from one another and rotatably supported on the base.

15. The edger as claimed in claim 14,
each of said wheels presenting a respective diametrical surface,
each of said diametrical surfaces extending at least partly outwardly beyond at least two of said outer edges,
said linearly spaced points being defined on said diametrical surfaces.

16. The edger as claimed in claim 1; and
a handle assembly coupled to the head assembly,
said head assembly including a base,
said handle assembly being pivotally coupled to said base.

17. The edger as claimed in claim 16,
said base including a generally flat rectangular plate,
said plate being positioned between said applicator and said handle assembly.

18. The edger as claimed in claim 16,
said handle assembly being pivotal relative to said base through substantially one-hundred and eighty degrees of pivot.

19. The edger as claimed in claim 16,
said handle assembly including a handle and an extension pole removably coupled to the handle.

20. An edger for applying paint to a surface, said edger comprising:
a head assembly including a base, a pad supported on the base, and an edging guide coupled to the base,
said pad being operable to store a quantity of paint therein and defining a paint-applying face operable to engage the surface and thereby transfer paint to the surface,
said face presenting relatively unparallel first and second outer edges,
said edging guide including first and second rotatable wheels,
said first wheel presenting a first diametrical surface having at least a portion thereof extending outwardly beyond said first outer edge,
said second wheel presenting a second diametrical surface having at least a portion thereof extending outwardly beyond said second outer edge.

21. The edger as claimed in claim 20,
said base including a generally flat rectangular plate,
said pad being removably coupled to the plate.

22. The edger as claimed in claim 21,
said pad being generally rectangular and coextensive with said plate so that the first and second outer edges are generally coplanar and perpendicular.

23. The edger as claimed in claim 20,
said edging guide including a third wheel rotatably supported on said base and spaced from said first and second wheels.

24. The edger as claimed in claim 23,
said third wheel presenting a third diametrical surface,
at least a portion of said third diametrical surface extending outwardly beyond said first outer edge,
at least an additional portion of said third diametrical surface extending outwardly beyond said second outer edge.

25. The edger as claimed in claim 24,
said face further presenting a third outer edge spaced from said first outer edge,
said third outer edge being generally coplanar and parallel to said first outer edge,
at least an additional portion of said second diametrical surface extending outwardly beyond said third outer edge.

26. The edger as claimed in claim 25,
said edging guide including a fourth wheel rotatably supported on said base and spaced from said first, second and third wheels,
said fourth wheel presenting a fourth diametrical surface,
at least a portion of said fourth diametrical surface extending outwardly beyond said third outer edge.

27. The edger as claimed in claim 26,
said face further presenting a fourth outer edge spaced from said second outer edge,
said fourth outer edge being generally coplanar and parallel to said second outer edge,
at least an additional portion of said fourth diametrical surface extending outwardly beyond said fourth outer edge.

28. The edger as claimed in claim 27,
at least an additional portion of said first diametrical surface extending outwardly beyond said fourth outer edge.

29. The edger as claimed in claim 20; and
a handle assembly coupled to the base,
said handle assembly being pivotally coupled to said base.

30. The edger as claimed in claim 29,
said base including a generally flat rectangular plate,
said plate being positioned between said pad and said handle assembly.

31. The edger as claimed in claim 29,
said handle assembly being pivotal relative to said base through substantially one-hundred and eighty degrees of pivot.

32. The edger as claimed in claim 29,
said handle assembly including a handle and an extension pole removably coupled to the handle.
